(19) United States
(12) Patent Application Publication
(10) Pub. No.: US 2012/0183039 A1
(43) Pub. Date: Jul. 19, 2012

(54) CODING STATIC VIDEO DATA WITH A BASELINE ENCODER

(75) Inventors: Krishnan Rajamani, San Diego, CA (US); Judit Martinez Bauza, San Diego, CA (US)

(73) Assignee: QUALCOMM Incorporated, San Diego, CA (US)

(21) Appl. No.: 13/006,271

(22) Filed: Jan. 13, 2011

(51) Int. Cl. H04N 7/26

(52) U.S. Cl. 375/240.02; 375/E07.026

(57) ABSTRACT

In general, techniques are described for encoding static video data using a baseline video encoder. A device comprising a baseline video encoder, a wireless interface and a control unit may implement the techniques. The baseline video encoder encodes a portion of this static video data at a first quality. The wireless interface wirelessly transmits the encoded first portion to a remote display device. The control unit identifies a region of interest in the portion of the video data to be re-encoded at a second quality, where the second quality is higher than the first quality. The baseline video encoder re-encodes the identified region of interest at the second quality without re-encoding any other regions of the portion of the video data at the second quality. The wireless interface wirelessly transmits the re-encoded identified region of interest to the remote display device.

### TECHNICAL FIELD

The invention relates to encoding video data and, more particularly, encoding static video data for wireless transmission.

### BACKGROUND

Current video coding standards specify a form of video compression optimized to compress so-called “natural images” that form traditional and newer forms of video data. The phrase “natural images” refers to images captured of natural scenes, such as those captured in the form of home videos, Hollywood movies, television shows, and other types of traditional video data of this sort. These conventional video coding standards also adequately compress newer forms of video data, such as video data captured as part of video telephony or produced using computer graphics or computer animation. These newer forms of video data are generally similar to the more traditional form of video data noted above in that these newer forms of video data also relate to or mimic images that occur naturally. A property of the traditional and newer forms of video data is that the so-called “natural images” of these forms of video data change rapidly. As a result, conventional video coding standards have been optimized to efficiently compress rapidly changing images of traditional video data.

### SUMMARY

In general, various aspects of techniques are described for efficiently compressing static video data. The phrase “static video data” is used in this disclosure to refer to images or frames of video data that may be substantially similar to those images or frames in the series of images or frames forming the video data that are directly preceding or succeeding the image. In this sense, the static video data may be considered as frames in a series of frames that form video data that depict the same or at least substantially similar image to that of a frame preceding or succeeding the frame. Rather than modify an existing profile or propose a new profile for encoding static video data, the techniques leverage existing aspects of the standard, non-scalable, or so-called “baseline” profile provided by at least one video coding standard to encode this static video data. By leveraging this existing standard or baseline profile for encoding this more static form of video data, the techniques may enable nearly ubiquitous decoding this static video data by any display, including wireless display devices that receive video data via a wireless communication channel, considering that the standard or baseline profile is implemented by nearly every device that adheres to these standards. In addition, the standard or baseline profile often features a low implementation complexity in comparison to modified or new profiles and for this reason, the techniques may also provide a low complexity way of encoding static video data.

In one aspect, a method for performing a non-scalable encoding process to encode video data that is to be wirelessly transmitted to a remote display device, the method comprises encoding, with a device, a portion of the video data at a first quality, wirelessly transmitting, with the device, the encoded first portion to the remote display device, and identifying, with the device, a region of interest in the portion of the video data to be re-encoded at a second quality, wherein the second quality is higher than the first quality. The method further comprises re-encoding, with the device, the identified region of interest at the second quality without re-encoding any other regions of the portion of the video data at the second quality and wirelessly transmitting, with the device, the re-encoded identified region of interest to the remote display device.

In another aspect, a device for performing a non-scalable encoding process to encode video data that is to be wirelessly transmitted to a remote display device comprises a video encoder that encodes a portion of the video data at a first quality, a wireless interface that wirelessly transmits the encoded first portion to the remote display device and a control unit identifies a region of interest in the portion of the video data to be re-encoded at a second quality, wherein the second quality is higher than the first quality. The video encoder re-encodes the identified region of interest at the second quality without re-encoding any other regions of the portion of the video data at the second quality. The wireless interface further wirelessly transmits the re-encoded identified region of interest to the remote display device.

In another aspect, a device for performing a non-scalable encoding process to encode video data that is to be wirelessly transmitted to a remote display device, the device comprises means for encoding a portion of the video data at a first quality, means for wirelessly transmitting the encoded first portion to the remote display device, means for identifying a region of interest in the portion of the video data to be re-encoded at a second quality, wherein the second quality is higher than the first quality, means for re-encoding the identified region of interest at the second quality without re-encoding any other regions of the portion of the video data at the second quality and means for wirelessly transmitting the re-encoded identified region of interest to the remote display device.

In another aspect, a non-transitory computer-readable storage medium comprising instructions for performing a non-scalable encoding process to encode video data that is to be wirelessly transmitted to a remote display device, the instructions, when executed, cause one or more processor to encode a portion of the video data at a first quality, wirelessly transmit the encoded first portion to the remote display device, identify a region of interest in the portion of the video data to be re-encoded at a second quality, wherein the second quality is higher than the first quality, re-encode the identified region of interest at the second quality without re-encoding any other regions of the portion of the video data at the second quality and wirelessly transmit the re-encoded identified region of interest to the remote display device.

The details of one or more embodiments of the techniques are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an exemplary system in which a mobile device implements the techniques described in this disclosure to efficiently encode static video data for wireless transmission to a wireless display device.

FIG. 2 is a block diagram illustrating an example implementation of the static video encoding manger of the mobile device shown in the example of FIG. 1.

FIGS. 3A, 3B provide a flowchart illustrating example operation of a device in implementing the static video encoding techniques described in this disclosure.

### DETAILED DESCRIPTION

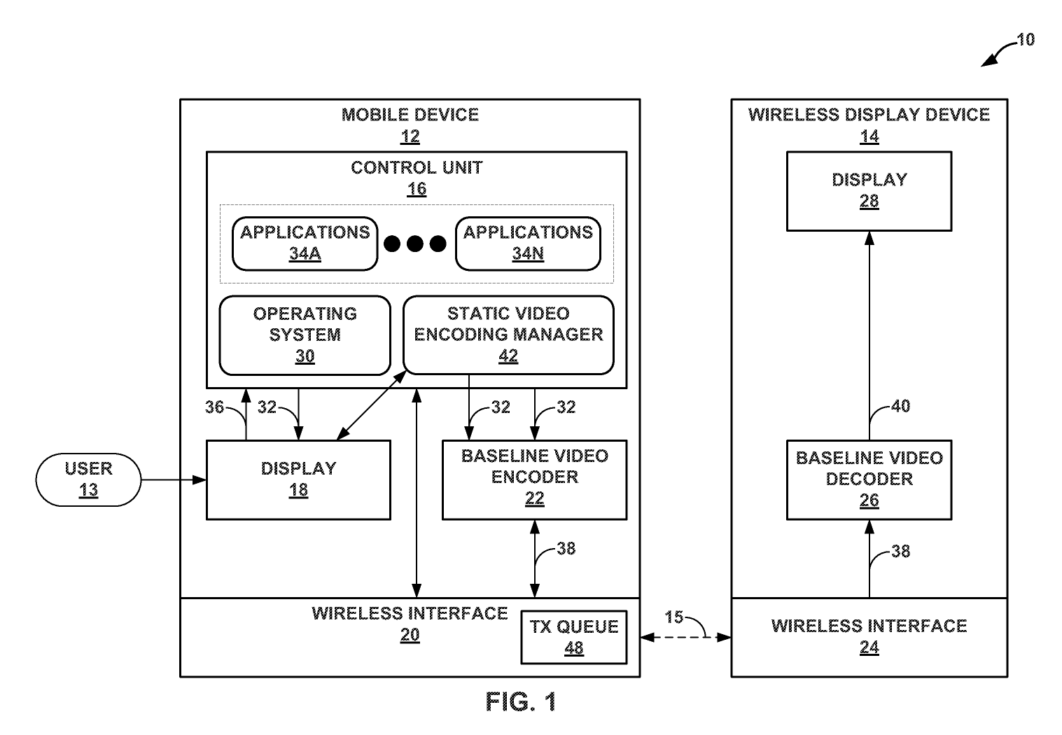

FIG. 1 is a block diagram illustrating an exemplary system 10 in which a mobile device 12 implements the techniques described in this disclosure to efficiently encode static video data for wireless transmission to a wireless display device 14. As shown in the example of FIG. 1, system 10 includes a mobile device 12 and a wireless display device 14, which communicates with mobile device 12 via a wireless communication channel 15. In the example of FIG. 1, mobile device 12 is assumed to represent a cellular phone or wireless handset that is generally referred to as a “smart phone” due to the extended set of capabilities offered by these types of devices, such as the ability to interface and navigate the Internet, capture images and/or video, engage in text messaging, provide scheduling and calendar operations, execute applications similar to laptop and desktop computers, and otherwise provide a quasi-computing environment comparable to laptop and desktop computers. However, while described with respect to a mobile device 12 of this type, the techniques may be implemented by any type of device capable of wirelessly transmitting static video data, including such devices as a laptop computer, a desktop computer, a workstation, a slate or tablet computer, a so-called “netbook,” a global positioning system (GPS) device, a personal digital assistant (PDA) device, a personal media player, and a display device, to name a few examples.

Wireless display device 14 represents any type of display device capable of wireless receiving video data, including so-called wireless or Internet-ready televisions and wireless monitors. Again, while described with respect to a wireless display device 14, the techniques may be implemented with respect to any device or combination of devices that are capable of receiving video data wirelessly, such as a computing device that provides the wireless interface for a monitor wired to the computer or any other such device or combination of devices.

Mobile device 12 includes a control unit 16, a display 18, a wireless interface 20 and a baseline video encoder 22. Control unit 16 may comprise one or more processors (not shown in FIG. 1) that execute software instructions, such as those used to define a software or computer program, stored to a computer-readable storage medium (again, not shown in FIG. 1), such as a storage device (e.g., a disk drive, or an optical drive) or memory (e.g., a Flash memory, random access memory or RAM) or any other type of volatile or non-volatile memory that stores instructions (e.g., in the form of a computer program or other executable) to cause a programmable processor to perform the techniques described in this disclosure. Alternatively, control unit 16 may comprise dedicated hardware, such as one or more integrated circuits, one or more Application Specific Integrated Circuits (ASICs), one or more Application Specific Special Processors (ASSPs), one or more Field Programmable Gate Arrays (FPGAs), or any combination of the foregoing examples of dedicated hardware, for performing the techniques described in this disclosure.

Display 18 may comprise any type of display, including an organic light emitting diode (OLED) display, a liquid crystal display (LCD), a light emitting diode (LED) display, a LED-LCD, a plasma display, and a cathode-ray tube (CRT) display. Display 18 may include user interface aspects to provide some way by which user 13 may interface with mobile device 18. That is, display 18 may include touch sensitive elements by which to sense contact with either user 13 or some implement, such as a stylus. In this respect, display 18 may represent a touchscreen display, such as a resistive touchscreen display and a capacitive touchscreen display. Wireless interface 20 represents any interface by which wireless communications may occur. Examples of wireless interface 20 include a Bluetooth™ interface and an interface that complies with one or more of the Institute of Electrical and Electronics Engineers 802.11 family of standards.

Baseline video encoder 22 may represent hardware or a combination of hardware and software that implements one or more non-scalable video compression-decompression (“codecs”) algorithms for coding video data. The term “codec” is used regardless of whether video encoder 22 implements both the encoding (i.e., compression) and the decoding (i.e., decompression) aspects of a given codec. The term “non-scalable codecs” refers to codecs that do not inherently provide a mechanism by which to iteratively update or scale the quality of video data through the use of multiple layers. Scalable codecs are generally much more complex in terms of implementation complexity as multiple layers of video data may be generated and transmitted in such a manner that higher layers augment lower layers rather than replace lower layers.

Baseline video encoder 22 may implement codecs as defined by a video coding standard, such as the International Telecommunication Union Standardization Sector (ITU-T) H.264/Moving Picture Experts Group-4 (MPEG-4), Part 10, Advanced Video Coding (AVC) standard (hereinafter “H.264/ MPEG-4 AVC” standard). Codes in the H. 264/MPEG-4 AVC standard are generally referred to as profiles, where video encoder 22 is assumed to implement a baseline profile, hence the name “baseline video encoder 22.” The baseline profile is generally defined as the profile that provides the lowest implementation complexity necessary to meet the baseline definition of the standard. While referred to as a video encoder, video encoder 22 may include a decoder to facilitate the encoding of video data and also provide decoding functionality.

Often, the standards, such as H.264/MPEG-4 AVC, defines additional profiles that a video encoder may implement that increase the implementation complexity but offer further compression benefits in certain contexts. For example, H.264/MPEG-4 AVC provides a main profile for encoding standard definition television video data, an extended profile for encoding streaming video data, a high profile for encoding high definition television video data, a stereo high profile for encoding stereoscopic 3D video data, and a number of other profiles that generally add functionality to and thereby increase the implementation complexity with respect to the baseline profile. In each instance, however, the baseline profile is generally supported by these more complex profiles, meaning implementation of the high profile necessarily implements the baseline profile as the high profile builds on but does not negate the baseline profile. Consequently, reference to baseline video encoder 22 in this disclosure should not limit the techniques to those video encoders that solely implement the baseline profile but should incorporate those video encoders that implement the more complex profiles that also support or build upon the baseline profile although these more advanced or complex profiles may not be necessary to implement the techniques described in this disclosure.

Wireless display device 14 includes a wireless interface 24, a baseline video decoder 26 and a display 28. Wireless interface 24 may be substantially similar to above-described wireless interface 20 of mobile device 12. Baseline video decoder 26 may represents hardware or a combination of hardware and software that implements one or more video codecs for decoding the video data. Baseline video decoder 26 may implement the same baseline profile as that implemented by video encoder 22. In some instances, baseline video decoder 26 may also include a video encoder to provide video encoding functionality. In other instances, baseline video decoder 26 only implements the video decoding aspects of the baseline profile to provide video decoding functionality without providing video encoding functionality. Display 28 may, like display 18, comprise any type of display, including an organic light emitting diode (OLED) display, a liquid crystal display (LCD), a light emitting diode (LED) display, a LED-LCD, a plasma display, and a cathode-ray tube (CRT) display.

Control unit 16 of mobile device 12 may execute an operating system 30 that presents an interface in the form of video data 32 to display 18. Display 18 may present this interface and user 13 may interact with the interface via display 18 to control the operation of mobile device 12. The interface generally includes a number of icons representative of applications 34A-34N (“applications 34”), which in the context of mobile devices are commonly referred to as “apps.” One or more of applications 34 may be preloaded on or packaged with operating system 30. User 13 may also download or otherwise load one or more of applications 34 onto mobile device 12. Applications 34 generally represent versions (often, scaled-down versions) of applications executed by laptop or desktop computers that have been retooled to fit the limited display sizes common on mobile devices and accommodate user input by way of a touchscreen device, such as display 18. Applications 34 may comprise document editing applications, image and/or video editing applications, texting applications, web or Internet browsing applications, gaming applications, management applications, music playback application, video playback applications or any other type of application capable of being executed by a mobile device 12 or any other type of computing device.

User 13 may interact with the interface presented by operating system 30 to select one or more of applications 34 by touching the icon representative of selected one or more applications 34. In response to detecting the contact with display 18, display 18 resolves the location of the contact and generates touch data 36 specifying one or more locations of the contact. Display 18 forwards touch data 36 to control unit 16, whereupon operating system 30 resolves which of the icons or other types of so-called “touches” were performed. If operating system 30 determines that an icon was selected, operating system 30 loads and executes the corresponding one of applications 34. If the operating system 30 determines that some other operation was performed, such as a navigation operation, operating system 30 updates its interface to reflect the navigation operation and forwards this updated interface to display 18 in the form of video data 18. While described with respect to a touchscreen display 18, user 13 may utilize other forms of user interfaces, such as a keyboard, a slider or rocker button, a push button, a microphone (in the form of voice commands for example) or any other user interface mechanism employed by mobile devices to facilitate input of data by users to make selections or navigate the interface provided by operating system 30 or, for that matter, any of applications 34.

In any event, given the limited sizes of mobile devices due to the demand for pocket-sized devices capable of being carried by user 13 throughout the day, display 18 is often limited in size to approximately four inches as measured diagonally across the display. This display size limitation often constrains development of applications 34 by forcing developers to develop these applications 34 to make the best use of the limited display size of these displays of mobile devices. Yet, despite the demand for pocket-sized mobile devices, users also desire a way to view the interfaces presented by operating system 30 and applications 34, which is shown as video data 32 in the example of FIG. 1, in a larger format. While there are ways of enabling a television or other display device to display video data provided by a mobile device, such as video data 32 provided by mobile device 12, these ways are often cumbersome in that they involve special cords to physically couple mobile device 12 to the television or other display and configuration of the mobile device to correctly output the video data.

Recently, wireless display devices, such as wireless display device 14 have emerged that can receive video data via a wireless interface, such as wireless interface 24. Displays of these wireless display devices, such as display 28 of wireless display device 14, are usually much larger than the displays provided by mobile devices. For example, a common display size for wireless display devices is 42 inches, as measured diagonally across the display. These wireless display devices are therefore generally well suited to provide an external and much larger display for displaying video data 32 provided by mobile device 12 in a larger format. As a result, mobile devices, such as mobile device 12, are being developed to make use of the larger display sizes presented by wireless display device 14 to accommodate the demand for being able to seamlessly view video data 32 provided by mobile device 12 in a larger format.

To more efficiently transmit video data 32 via wireless communication channel 15 (which is sometimes referred to as a “wireless communication link”) to wireless display device 14, mobile device 12 invokes baseline video encoder 22 to compress video data 32. Baseline video encoder 22 implements the baseline profile in accordance with H.264/MPEG-4 AVC standard to generate compressed video data 38. Compressed video data 38 is generally of a smaller size in terms of bytes than video data 32. Baseline video encoder 22 forwards compressed video data 38 to wireless interface 20, which stores compressed video data 38 to a transmission (TX) queue 48. Wireless interface 20 retrieves comopressed video data 38 from TX queue 48 and communicates compressed video data 38 via wireless communication channel 15 to wireless interface 24 of wireless display device 14. Wireless interface 24 forwards compressed video data 38 to baseline video decoder 26. Baseline video decoder 26 then decodes compressed video data 38 using the same baseline profile as that used to encode compressed video data 38 to generate decoded video data 40. Decoded video data 40 may be slightly different from video data 32 in that errors or other artifacts may be introduced during compression, transmission and decompression of video data 32. Baseline video decoder 26 forwards this decoded video data 40 to display 28, which presents decoded video data 40 for consumption by user 13.

While baseline video encoder 22 may efficiently compress so-called “natural video data” comprising images that generally change from frame-to-frame, the baseline profile implemented by baseline video encoder 22 is not well suited to encode what may be referred to as “static video data.” As used in this disclosure, static video data refers to images or frames of video data that may be substantially similar to those images or frames in the series of images or frames forming the video data that are directly preceding or succeeding the image. Generally, the baseline profile is optimized to compress natural video data that changes from frame-to-frame due to movement of the camera that captured the natural video data or the subject of the images.

To illustrate, the baseline profile generally requires that baseline video encoder 22 perform image compression techniques known as motion compensation to efficiently compress the frame-to-frame changes in pixel values. In performing motion compensation, video encoder 22 attempts to exploit common properties of natural video data where the only difference in pixel values between one frame and another is due to the movement of the camera or a subject being captured, such as a human face. Video encoder 22 implements motion compensation to search for a block of pixel values in a reference frame that matches a block of pixel values in a frame temporally close or adjacent to the reference frame. In this sense, video encoder 22 is looking for an offset of pixel values between frames due to movement of the camera or the subject of these frames. Upon finding a match, video encoder 22 generates a motion vector mapping the location of the block of pixel values in the temporally close frame to the reference frame and encodes the motion vector rather than the block of pixels, where the encoded motion vector represents the block of pixels using less bits than had the block of pixels been encoded itself. However, in static video data, the value of the pixel in the first frame is substantially the same as the value of the same pixel in the second frame located at the same location as the pixel in the first frame. Yet, the baseline profile still implements motion compensation despite that motion compensation will most likely return a motion vector indicating that the pixel values have not changed between frames. Baseline video encoder 22 therefore encodes a large number of these motion vectors indicating that the pixel values have not changed for each frame of static video data and repeatedly does so until the static video data is updated. This is inefficient in that baseline video encoder 22 performs motion compensation for video data that is known to be static and continues to perform motion compensation even though all of the motion vectors are the same.

To overcome these inefficiencies, many developers of codecs have proposed introducing new codecs designed specifically to accommodate static video data. Yet, developing and deploying these codecs may create fragmentation within the wireless display device market and the mobile device market, where one manufacturer of wireless display devices may develop and deploy a proprietary coded for encoding and decoding static video data that only works with certain ones of mobile devices. This fragmentation increases user frustration and may stall user adoption of using their wireless display devices as a larger display for their mobile devices to the same extent physical coupling requirements currently stall user adaption of using their televisions and other displays as a larger display for their mobile devices. Moreover, many wireless display devices may choose altogether not to adopt any of these proprietary or even open codecs due to specific hardware requirements of these codecs, costs associated with implementing the codecs and the like.

In accordance with the static video encoding techniques described in this disclosure, mobile device 12 employs baseline video encoder 22 to encode static video data 32 in a manner that may leverage the baseline profile to efficiently encode static video data 32. Rather than inefficiently encode static video data 32 using only the baseline profile implemented by baseline video encoder 22, control unit 16 of mobile device 12 executes a static video encoding manager 42 that detects when video data 32 is static. Upon detecting a portion of video data 32 that is static, static video encoding manger 42 issues one or more commands or messages to instruct baseline video encoder 22 to more efficiently encode the static video data over standard video encoding performed in accordance with standard implementations of the baseline profile, as described below in more detail. By leveraging the baseline profile in the manner described below, static video encoding manger 42 may more efficiently encode static video data 32 while potentially avoiding the introduction of fragmentation. Moreover, by using the baseline profile, the techniques do not introduce any additional implementation complexity that would arise had a special purpose static video codec been introduced, which may facilitate adoption of this techniques by wireless display device manufactures in that it does not involve any special purpose software or hardware to implement.

As an example, static video encoding manager 42 may, as noted above, first monitor display 18 to detect when display 18 is idle. Static video encoding manger 42 may monitor display 18 to detect timeouts for local display update capture. Timeouts of this nature occur when the buffer is not refreshed or reloaded before a set time. When a timeout occurs, display 18 merely refreshes the display with the timeout image data stored to the buffer, which is not shown in FIG. 1 for ease of illustration purposes. When static video encoding manger 42 does not detect a timeout, static video encoding manager 42 determines that video data 32 currently being displayed is natural video data. Assuming user 13 has previously selected to display video data 32 on remote wireless display device 14, static video encoding manager 42 forwards video data 32 to baseline video encoder 22. Baseline video encoding 22 encodes video data 32 in the conventional manner. When static video encoding manager 42 determines that video data 32 is static, static video encoding manager 42 issues a message or command 44 to baseline video encoder 22 instructing baseline video encoder 22 to encodes a first portion of static video data 32, such as a first frame in the sequence of frames that form static video data 32, at a first quality. Typically, this first quality is of a low quality so that baseline video encoder 22 may more quickly encode this static video data 32.

Baseline video encoder 22 encodes the entire portion or frame, in this example, of static video data 32 at the first quality to generate encoded static video data 38. Baseline video encoder 22 then stores encoded static video data 38 to TX queue 48 of wireless interface 20. Wireless interface 20 then transmits this encoded static video data 38 stored to TX queue 48 via wireless communication channel 15 to wireless display device 14. By encoding this data at a first quality, baseline video encoder 22 may more quickly encode static video data 32 and reduce latency associated with encoding, transmitting and decoding this video data. The reduction in latency may improve the user experience in that display 28 of wireless display device 14 may more quickly receive and display this static video data in comparison to instances where baseline video encoder 22 encodes the entire frame at a higher quality.

After encoding and transmitting this static video data 32 at a first quality, static video encoding manager 42 identifies a region of interest (ROI) in the portion of static video data 32 to be re-encoded at a second quality that is higher than the first quality. This ROI may comprise one or more blocks of the portion or frame of static video data 32, such as one or more 4×4 blocks of pixel values, one or more 4×8 blocks of pixel values, one or more 8×4 blocks of pixel values, one or more 8×8 blocks of pixel values, one or more 8×16 blocks of pixel values, one or more 16×8 blocks of pixel values, or one or more 16×16 blocks of pixel values. Pixel values may refer to the red, blue and green color values, as well as, the gamma values for a particular pixel in a frame. After selecting this ROI, static video encoding manger 42 next issues another message or command 44 to baseline video encoder 22 to encode the selected ROI at the second higher quality but not to re-encode any other region of the portion, i.e., frame in this example, at the second higher quality. Baseline video encoder 22 then re-encodes the selected ROI at the second quality without re-encoding any other regions of the portion of static video data 32 at the second higher quality.

Baseline video encoder 22 may encode this selected ROI at the second quality as a new frame, where this new encoded frame includes the encoded ROI encoded at the second higher quality and a “no change” indication for every other ROI. This “no change” indication indicates that the other regions have not changed from the previous frame, which in this instance is the frame previously encoded at the first quality. Baseline video decoder 26 may receive this new frame and merge the other regions corresponding to the “no change” indications into the new frame so that only the selected ROI in the new frame is encoded at the second higher quality and the remaining regions remain at the first quality. Alternatively, baseline video decoder 26 may encode this ROI as a slice that each belong to the same frame to achieve a similar result.

Static video encoding manager 42 continues to monitor display 18 to determine whether video data 32 has changed. If video data 32 remains static, static video encoding manager 32 selects a ROI of the frame of static video data 32 that has not yet been re-encoded at the second higher quality and again issues one of commands or messages 44 to baseline video encoder 22 instructing baseline video encoder 22 to encode the selected ROI at the second higher quality. Baseline video encoder 22 then re-encodes the selected ROI at the second quality without re-encoding any other regions of the portion of static video data 32 at the second higher quality. This process continues until the entire portion of static video data 32 has been re-encoded at the second higher quality or until static video encoding manager 32 detects a change in video data 32 when monitoring display 18. In this way, the techniques may successively refine static video data 32 to incrementally increase the quality of static video data 32 sent to remote wireless display device 14.

In some instances, static video encoding manager 42 does not stop re-encoding static video data 32 upon re-encoding the entire frame of static video data 32 at the second higher quality. Rather, static video encoding manager 32 may select a ROI of the frame of static video data 32 and issue a command or message 44 instructing baseline video encoder 22 to encode the selected ROI at a third quality that is higher than the second quality. Baseline video encoder 22 then re-encodes the selected ROI at the third quality without re-encoding any other regions of the portion of static video data 32 at the third even higher quality. Static video encoding manager 42 may continue to monitor display 18 for changes, but if no changes are detected, static video encoding manager 42 may continue to select ROIs and instruct baseline video encoder 22 to re-encode these ROIs once again.

If a change is detected, static video encoding manager 32 determines that the video data is natural and may instruct baseline video encoder 22 to encode natural video data 32 in the conventional manner. In some instances, video encoding manager 32 may first issue messages or commands 44 that instruct baseline video encoder 22 to encode this detected changed frame of video data 32 at the first quality under the assumption that video data 32 is static. If static video encoding manager 42 does not detect any additional changes, static video encoding manager 42 may then begin the process of selecting ROIs for encoding at the second higher quality. However, if static video encoding manager 42 detects additional changes within a given amount of time or a successive configurable or predefined number of changes, static video encoding manager 42 may determine that video data 32 is nature and, as a result, may issue a command or message 44 instructing baseline video encoder 22 to revert to conventional baseline encoding. Static video encoding manager 42 may then forward this natural video data 32 to baseline video encoder 22, which proceeds to perform conventional baseline encoding to encode natural video data 32.

In some instances, static video encoding manager 42 may detect a change in display 18 but rather than instruct baseline video encoder 22 to re-encode this changed frame at the first quality or revert to conventional baseline encoding, static video encoding manager 42 may assess the extent of the change. If the change is minor, as measured for instance as a percentage change with respect to the previous frame of static video data 32, static video encoding manager 42 may select as the ROI the region impacted by this minor change. Static video encoding manager 42 may then issue commands or messages 44, instructing baseline video encoder 22 to re-encode this ROI at the second higher quality. Baseline video encoder 22 then re-encodes this impacted ROI at the second higher quality.

In this way, the static video encoding techniques described in this disclosure may leverage the standard or baseline profile defined by many video encoding standards, such as the H.264/MPEG-4 AVC standard, to efficiently encode static video data without requiring any special purpose codec or profile. Moreover, the techniques utilize the baseline profile in a way that reduces latency with respect to the initial encoding, transmittal and display of the static video data, giving user 13 responsive feedback that the wireless transmittal of video data is operational and without issue. Assuming there are no changes to the static video data, the techniques then successively refine the static video data by re-encoding various ROIs of this video data at a higher quality. The techniques therefore balance the concerns of users with respect to both latency and quality. In addition, because the techniques rely only on the baseline profile that has been widely adopted or implemented by many, if not most, displays, the techniques do not require wireless display device manufactures to implement a costly and specialized video decoder capable of implementing this specialized profile that may hamper adoption of wireless communication of video data to displays.

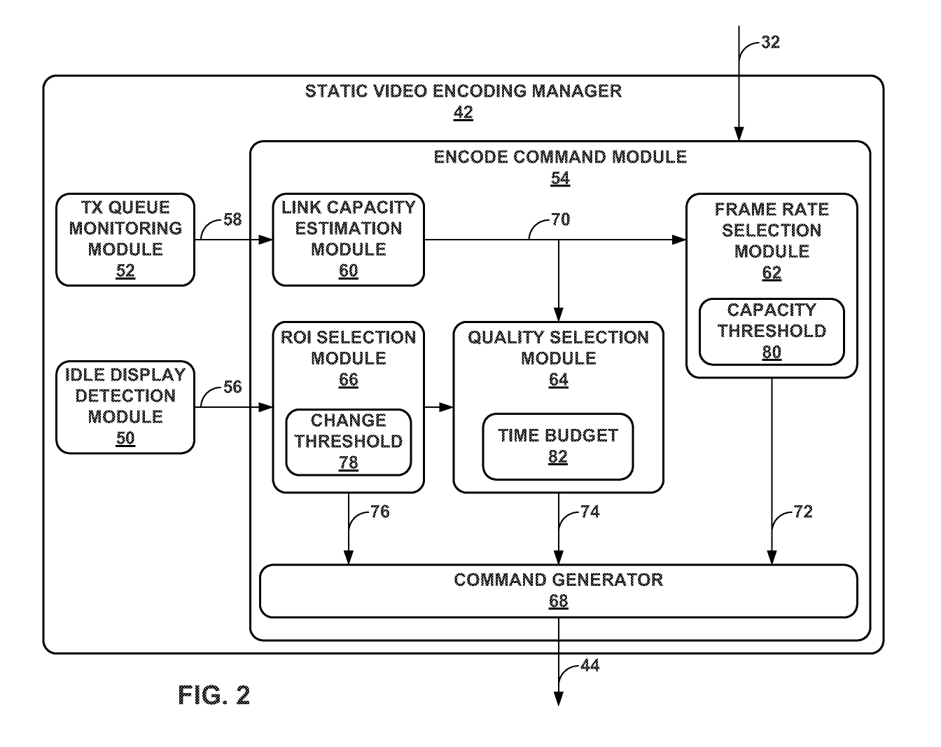

FIG. 2 is a block diagram illustrating an example implementation of static video encoding manger 42 of FIG. 1. As shown in the example of FIG. 2, static video encoding manager 42 includes an idle display detection module 50, a transmission (TX) queue monitoring module 52 (“TX queue monitoring module 52”) and an encode command module 54. Idle display detection module 50 represents a module that monitors display 18 to detect when display 18 is idle. Idle display detection module 50 may forward an idle indication 56 request command module 54. While shown as residing within static video encoding manager 42, idle display detection module 50 may instead execute separate from static video encoding manager 42. Idle display detection module 50 may, for example, represent a display driver loaded into operating system 30 that is adapted to provide idle and active display indications 56 to static video encoding manager 42. The techniques should therefore not be limited in this respect to the example of FIG. 2. TX queue monitoring module 52 represents a module that monitors TX queue 48 to determine an amount of data stored to TX queue 48. TX queue monitoring module 52 may present this amount as a percentage of storage space available in TX queue 48 or a percentage of storage space consumed in TX queue 48. TX queue monitoring module 52 may forward this amount 58 to encode command module 54.

Encode command module 54 represents a module that generates commands 44 that instruct baseline video encoder 22 with regard to encoding video data 32. Encode command module 54, in this example, includes a link capacity estimation module 60, a frame rate selection module 62, a quality selection module 64, and ROI selection module 66 and a command generator 68. Link capacity estimation module 60 represents a module that estimates a link capacity of wireless communication channel 15 based on monitored amount 58 provided by TX queue monitoring module 52. Link capacity estimation module 60 forwards this estimated link capacity 70 to frame rate selection module 62. Frame rate selection module 62 represents a module 62 that selects a frame rate based on the estimated link capacity 70. Frame rate selection module 62 outputs selected frame rate 72 to command generator 68. Quality selection module 64 represents a module that selects a quality, such as the first or second quality, by which baseline video encoder 22 should encode video data 32. Quality selection module 64 outputs selected quality 74 to command generator 68. ROI selection module 66 represents a module that selects a ROI in accordance with one or more selection algorithms, which are not shown in the example of FIG. 2 for ease of illustration purposes. ROI selection module 66 outputs selected ROI 76 to command generator 68. Command generator 68 represents a module that generates commands 44 based on selected frame rate 72, selected quality 74, selected ROI 76 and idle indication 56.

Initially, static video encoding manager 42 invokes idle display detection module 56 to determine whether display 18 is idle or active. If idle display detection module 50 determines that display 18 is active, idle display detection module 50 issues idle indication 56 indicating that display 18 is active. In response to this idle indication 56, encode command module 54 invokes ROI selection module 66 to estimate or otherwise determine the extent of the change. That is, ROI selection module 66 may examine the current frame of video data 32 in comparison to the last frame of static video data and assess the extent of change as a percentage change between the pixel values of these frames.

ROI selection module 66 may store a change threshold 78 that defines a threshold by which to measure the determined percentage change. If the determined percentage change exceeds the threshold, ROI selection module 66 indicates that the current frame is to be encoded, either at the first lower quality or in the conventional manner. That is, ROI selection module 66 may determine that current video data 32 is natural video data after receiving a set or configurable number of successive non-idle or active display indications 56 within a set or configurable period of time. If this is the first active display indication 56 after at least one idle display indication 56, ROI selection module 66 may determine that the entire frame of current video data 32 need be re-encoded at the first quality. However, if ROI selection module 66 receives a number of active display indications 56 within a set period of time, ROI selection module 66 may generate an ROI selection 76 that indicates baseline video encoder 22 should revert to conventional video encoding techniques. Alternatively, if ROI selection module 66 determines that the determined extent of change does not exceed change threshold 78, ROI selection module 66 may select the ROI covering the changes area of the frame of current video data 32 for re-encoding at the second higher quality.

However, if idle display detection module 50 issues an idle indication 56 indicating that display 18 is idle, ROI selection module 66 either, if this is the first such idle indication 56 after a number of successive change indications, selects the entire frame as the ROI. ROI selection module 66 informs quality selection module 64 of the status of the display so that quality selection module 64 knows to select the first quality. If ROI selection module 66 has already selected the entire frame as the ROI previously, ROI selection module 66 selects an ROI of the frame in accordance with a selection algorithm. ROI selection module 66 may include a number of selection algorithms that define how the selection should be performed.

An example selection algorithm includes a reading order selection algorithm that selects ROIs from top left to bottom right in standard English reading order. Another example selection algorithm is a top to bottom selection algorithm that selects the top left ROI followed by the ROI directly below the previously selected ROI until the bottom is reached and then the next column of ROIs is selected until all of the ROIs are selected for encoding at the second higher quality. A third exemplary selection algorithm is a center out selection algorithm that encodes the center ROI followed by the next most center ROI until all of the ROIs are selected. Yet another selection algorithm involves an analysis of the frame to select an ROI most likely to be the center or object of attention to a viewer, such as a face in a photograph, where this process continues selecting the most likely center of attention of the remaining regions until all of the regions are selected. Another selection algorithm may involve selection of ROIs based on entropy level (e.g., where higher entropy regions are selected first). Still another selection algorithm may involve selecting the ROI that resumes a previously terminated selection sequence. ROI selection module 66 may automatically select a selection algorithm based on an assessment of static video data 32 or may be configured to use a given selection algorithm either by user 13 or by static video encoding manager 42.

Meanwhile, TX queue monitoring module 52 may periodically monitor TX queue 48 to determine an amount of data currently stored to TX queue 48. TX queue monitoring module 52 may forward TX queue amount 58 to link capacity estimation unit 60. Link capacity estimation unit 60 then estimates an amount of bandwidth is available for transmission of data over wireless communication channel 15. Link capacity estimation module 60 forwards this link capacity estimate 70 to frame rate selection module 62. Frame rate selection module 62 utilizes this link capacity estimate 70 in selecting frame rate 72. Frame rate selection module 62 may store a capacity threshold 80 that defines a threshold by which to compare link capacity estimate 70. If link capacity estimate 70 is less than capacity threshold 80, frame rate selection module 62 may select a reduced frame rate 72 in comparison to a previously selected frame rate. Otherwise, if link capacity estimate 70 is greater than capacity threshold 80, frame rate selection module 62 maintains or increases the currently selected frame rate 72. In this manner, frame rate selection module 62 accommodates low bandwidth or noisy links or wireless communication channels 15 by reducing the number of frames that are sent via this channel 15. By reducing frame rate 72, frame rate selection module 62 avoids overrunning TX queue 48, which may result in lost frames, inconsistent behavior, and latency.

Encode command module 54 also invokes quality selection module 64 to select the first and second qualities used to first encode the frame in its entirety and second to successively encode the selected ROIs. Quality selection module 64 may store a time budget 82 that defines a period of time by which to complete the static encoding process for any given static frame. Quality selection module 64 may select the second quality so that all of the regions of the frame may be re-encoded at the second quality in the given time budget 82. Quality selection module 64 may approximate times necessary to encode a given ROI at the second quality or monitor video encoder 22 to determine these times with more precision. Alternatively, command generator 68 may inform quality selection module 64 of when one of commands 68 instruction baseline video encoder 22 to encode an ROI at the second quality is sent and TX queue monitoring module 62 may inform quality selection module 64 of the time at which the ROI specified in command 68 was stored to TX queue 48 so that quality selection module 64 may derive an approximate time to encode each of these ROIs. Quality selection module 64 also receives link capacity estimate 70, which it uses to determine the second higher quality. A higher link capacity estimate 70 allows for transmittal of video data encoded at a higher quality, while a lower link capacity estimate 70 allows for transmittal of video data encoded at a lower quality. Quality selection module 64 may select this second quality 74 based on both link capacity estimate 70 and time budget 82 so that the encoding and transmittal of static video data 32 at the second higher quality may occur within specified time budget 82.

Command generator 68 receives each of selected frame rate 72, selected quality 74 and selected ROI 76. Based on selected frame rate 72, selected quality 74 and selected ROI, command generator 68 generates command 44 instructing baseline video encoder 22 to encode selected ROI 74 at selected quality 74 to achieve selected frame rate 72. Command generator 68 then forwards this command 44 to baseline video encoder 22.

As noted above, change threshold 78, capacity threshold 80m time budget 82 and the selection algorithm may be predefined or configurable. In some instances, static video encoding manager 42 may maintain profiles that each defines a different set of values for change threshold 78, capacity threshold 80 and time budget 82 and indicates a selection algorithm. Static video encoding manager 42 may be configured by operating system 30 to utilize a different one of these profiles in response to executing different ones of application 34 or based on an analysis of video data 32. User 13 may configure these profiles and specify associations between these profiles and applications 34, which operating system 30 may maintain and utilize to instruct static video encoding manager 42. Alternatively, applications 34 may interface with operating system 30 to specify or, in some instances, static video encoding manager 42 to specify which profile should be employed when encoding video data from these applications 34. User 13 may, in addition, define preferences that override these application defined profile associations. In this respect, the techqnieus provide a highly customizable platform by which to accommodate a wide variety of users and application developers to further promote adoption of wireless display of video data provided by mobile device 12.

Once concern to consider when selecting profiles for various applications is incremental latency, which refers to how long it takes to update wireless display device 14 in response to a new display update. Incremental latency is incurred when display 18 is updated. This latency is a function of the length or amount 58 stored to TX queue 48 when the display update arrives, as the data stored to TX queue 48 takes precedence over later data and thereby reflects the latency inherent in updating wireless display device 14 with the new display update. If the update arrives after time budget 82 has expired, there is no incremental latency (to the extent that link capacity 70 is accurate and the actual encoder bitrate is close to the estimate for the specified quality). However, if the update arrives before time budget 82 has expired, incremental queuing latency depends on capacity threshold 80. A lower value for capacity threshold 80 results in lower incremental latency as the frame rate is reduced earlier, which results a fewer number of frames that are stored to TX queue 48. However, a lower value for capacity threshold 80 also impacts the percent completion of the refinement sequence when an update arrives. That is, setting capacity threshold 80 to a lower value may reduce the speed with which ROIs are encoded at the second higher quality and thereby reduce the percentage of ROIs that are encoded at the second higher quality in comparison to when capacity threshold 80 is set to a higher value. In any event, many of these values for change threshold 78, capacity threshold 80 and time budget 82 feature tradeoffs that should be considered carefully when developing value profiles for these configurable aspects of the techniques described in this disclosure.

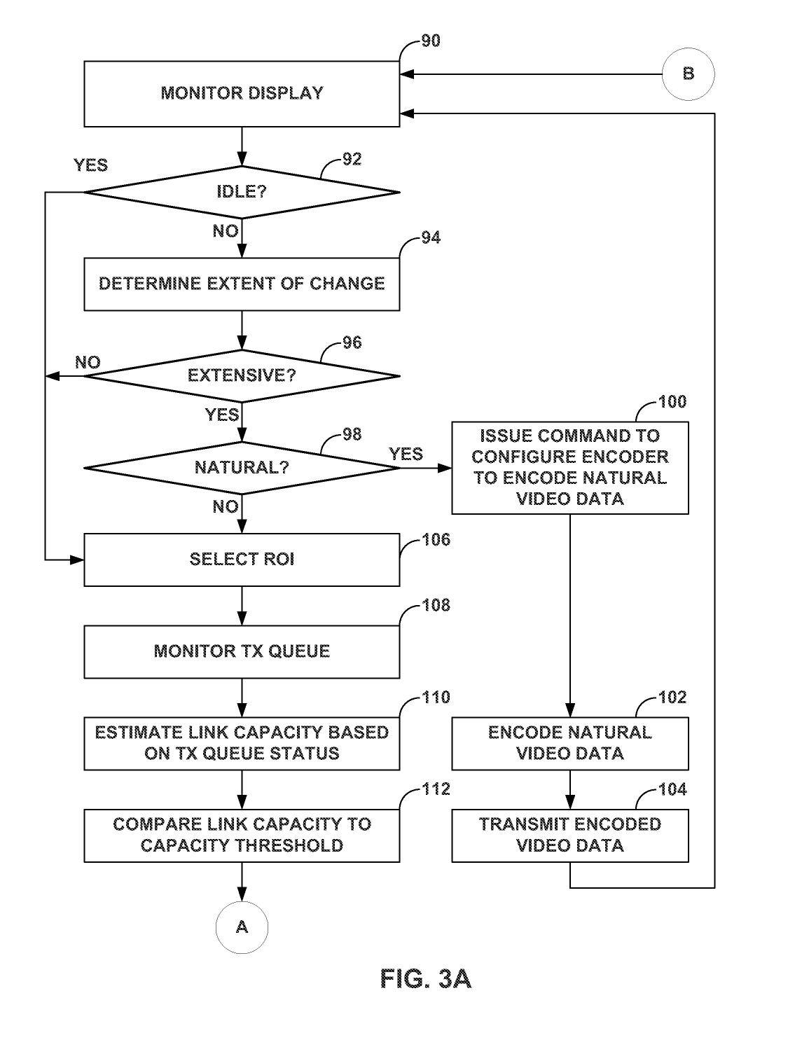

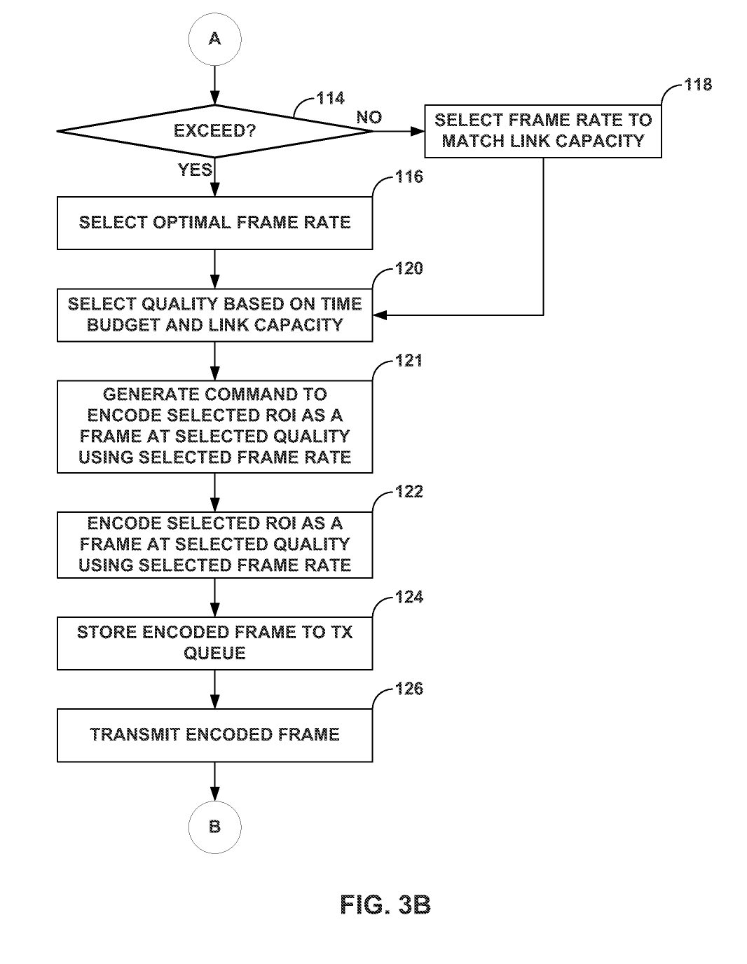

FIGS. 3A, 3B provide a flowchart illustrating example operation of a device, such as mobile device 12 of FIG. 1, in implementing the static video encoding techniques described in this disclosure. While described below with respect to mobile device 12 of FIG. 1, the techniques may be implemented by any device capable of wirelessly communicating video data to a remote display.

Initially, mobile device 12 receives some input from user 13 requesting that video data 32 be communicated wirelessly to remote wireless display device 14. This input may be received via display 18 or otherwise specified using some other user interface mechanism, such as those described above. In response to this input requesting that video data 32 be communicated wirelessly to remote wireless display device 14, control unit 16 of mobile device 12 invokes static video encoding manager 42, which is shown in more detail in FIG. 2, to manage encoding of video data 32 in accordance with the static video encoding techniques described in this disclosure.

Referring first to FIG. 3A, static video encoding manager 42, once invoked, then executes idle display detection module 50 to monitor display 18 in the manner described above by, for example, monitoring timeouts for local display update capture (90). Idle display detection module 50 monitors display 18 so as to determine whether the display is active or idle. In response to determining that the display is not idle but active (“NO” 92), idle display detection module 50 generates an active display indication 56 and forwards this active display indication 56 to ROI selection module 66. In response to this active display indication 56, ROI selection module 66 next determines the extent of change between this current frame of video data and the previous frame of video data, as described above (94). ROI selection module 66 stores change threshold 78 against which to compare the determined extent of change. ROI selection module 66 compares the determined extent of change to change threshold 78. If the determined extent of change exceeds change threshold 78 (“YES” 96), ROI selection module 66 next determines if video data 32 is so-called natural video data (98). ROI selection module 66 may be configured to identify video data 32 as natural video data upon receiving a set or configurable number of active display indications 56 within a set period of time, as one example.

If ROI selection module 66 determines that video data 32 is natural video data (“YES” 98), ROI selection module 66 interfaces with command generator 68 and causes command generator 68 to generate a command 44 that configures baseline video encoder 22 to encode natural video data in accordance with conventional video encoding techniques (100). Baseline video encoder 22 then encodes natural video data 32 to generate encoded video data 38 (102). Baseline video encoder 22 stores encoded video data 38 to TX queue 48. Wireless interface 20 then transmits encoded video data 38 via wireless communication channel 15 to wireless display device 14 (104).

Idle display detection module 50 continues to monitor display 18 (90). If idle display detection module 50 detects that display 18 is idle (“YES” 92), idle display detection module 50 generates an idle display indication 56 and forwards this indication 56 to ROI selection module 66. ROI selection module 66 receives this idle display indication 56 and determines that video data 32 is static video data. In response to this determination, ROI selection module 66 selects a ROI of static video data 32 to encode (106). Assuming this is the first idle display indication 56 that ROI selection module 66 has received after previously determining that video data 32 was natural video data, ROI selection module 66 selects the entire frame or portion of static video data 32 as the ROI. ROI selection module 66 also communicates this selection to quality selection module 64 so that quality selection module 64 knows to select a first quality rather than a second quality that is higher than the first.

Meanwhile, TX queue monitoring module 52 monitors the amount of data stored to TX queue 48 (108). TX queue monitoring module 52 forwards this amount 58 to link capacity estimation module 60. Link capacity estimation module 60 estimates link capacity 70 based on amount 58 (110). Link capacity estimation module 60 forwards link capacity 70 to frame rate selection module 62 and quality selection module 64. Frame rate selection module 62 receives link capacity 70 and compares link capacity 70 to capacity threshold 80 (112). Referring to FIG. 3B, if link capacity 70 exceeds capacity threshold 80 (“YES” 114), frame rate selection module 62 selects an optimal frame rate that is either equal to or greater than currently selected frame rate 72 (116). If link capacity 70 does not exceed capacity threshold 80 (“NO” 114), frame rate selection module 62 may select frame rate 72 to match the link capacity 70 (118). In any event, frame rate selection module 62 outputs selected frame rate 72 to command generator 68.

Quality selection module 64 also selects a quality based on time budget 82 and link capacity 70 in the manner described above (120). In this instance, ROI selection module 66 has instructed quality selection module 64 to select a first quality to encode the entire frame of static video data 32, where this first quality is less than a second quality used to iteratively encode regions of the frame constituting static video data 32. Quality selection module 64 outputs selected quality 74 to command generator 68.

Upon receiving selected ROI 76, selected quality 74 and selected frame rate 72, command generator 68 generates a command 44 instructing baseline video encoder 22 to encode selected ROI 76 (which is the entire frame in this instance) at selected quality 74 using selected frame rate 72 (121). Command generator 68 issues this command 44 to baseline video encoder 22. In response to this command 44, baseline video encoder 22 encodes selected ROI 76 as a frame at selected quality 74 (which is a first quality) using selected frame rate 72 (122). After encoding selected ROI 76 in this manner, baseline video encoder 22 stores encoded frame (which may be considered encoded video data 38) in TX queue 48 (124). Wireless interface 20 then transmits this encoded frame via wireless communication channel 15 to wireless display device 14 (126).

Referring back to the example of FIG. 3A, idle display detection module 50 continues to monitor display 18. Assuming idle display detection module 50 does not detect any changes or otherwise determines that display 18 is idle (“YES” 92), idle display detection module 50 generates an idle display indication 56, as described above. ROI selection module 66 receives this indication 56 and selects an ROI (106). In this instance, however, ROI selection module 66 determines that the entire frame has already been encoded at the first quality, considering ROI selection module 66 has received two successive idle display indications 56. Alternatively, if idle display detection module 66 is not synchronized with the iterative refinement process or polls display 18 in accordance with time periods that are greater than the time it takes to encode the entire first frame at the first quality, ROI selection module 66 may maintain state information with respect to the current refinement process. Based on this state information, ROI selection module 66 may determine that the entire frame has been encoded at the first quality and that a ROI needs to be selected in accordance with one of the ROI selection algorithms described above. ROI selection module 66 may inform quality selection module 64 that it needs to select a second quality rather than a first lower quality. ROI selection module 66 then forwards selected ROI 76 to command generator 68.

Again, TX queue monitoring module 52 monitors TX queue 58 to determine amount 56, which link capacity estimation module 60 bases the estimate of link capacity 70 (108, 110). Referring to FIG. 3B, frame rate selection module 62 compares link capacity 70 to capacity threshold 80 and, based on the comparison, selects either an optimal frame rate or a frame rate that matches link capacity 70, again as described above (112-118). Quality selection module 64 selects a second quality that is higher than the previously selected first quality again based on link capacity 70 and time budget 82 (120). Command generator 68 then generates a command 44 instructing baseline video encoder 22 to encode selected ROI 76 as a frame at selected quality 74 using selected frame rate 72 (121). Baseline video encoder 22 then encodes selected ROI 76 as a frame, filling in the other regions as “no change” regions in the manner described above, at selected quality 74 using selected frame rate 72 (122). Baseline video encoder 22 then stores this encoded frame to TX queue 48, whereupon wireless interface 20 transmits this encoded frame in the manner described above (124, 126).

Referring back to the example of FIG. 3A, idle display detection module 50 continues to monitor display 18. Assuming idle display detection module 50 detect a change or otherwise determines that display 18 is not idle but active (“NO” 92), idle display detection module 50 generates an active display indication 56, as described above. ROI selection module 66 receives this active indication 56 and determines the extent of the change 94. Above, it was assumed that this change was significant or extensive, yet, when the change is determined not to be extensive (“NO” 96), ROI selection module 106 selects the ROI as the region impacted by the change (106). Typically, ROI selection module 106 only determines that change is not extensive if the change is limited to a limited number of regions such that baseline video encoder 22 can be instructed within a reasonable time to encode these regions and thereby reflect this less extensive change on remote wireless display device 14 without encountering too much latency. As this is highly subjective from user to user, change threshold 82 may be defined to accommodate a wide range of preferences. In any event, the remainder of the processes follows in the manner substantially similar to the instance where ROI detection module 66 selects a ROI to encode at the second higher quality (108-126).

Continuing to refer to the example of FIG. 3A, ROI selection module 66 may alternatively determine that the extent of the change is extensive (“YES” 96), but that the change is not indicative of natural video data (“NO” 98). That is, ROI selection module 66 may have previously received one or more active display indications 56 but these active display indications 56 have not exceeded some threshold or set limit. In these instances, ROI selection module 66 continues to select the ROI as the entire frame until the set limit or threshold is exceeded (106). It may be that ROI selection module 56 receives a number of active display indications 56 and determines in each instance that the changes are extensive, yet the number of active display indications 56 does not exceed the threshold or set limit. In this instance, ROI selection module 66 may select each successive frame as the ROI (106) and instruct quality selection module 64 to select a first quality. Once the threshold is surpassed, ROI selection module 66 may determine that video data is natural (“YES” 98) and then interface with command generator 68 to cause command generator 68 to issue the command to configure encoder 22 to encode natural video data 32 in the manner described above (100).

In this way, rather than modify an existing profile or propose a new profile for encoding static video data, the techniques leverage existing aspects of the standard or so-called “baseline” profile provided by at least one video coding standard to encode this static video data. By leveraging this existing standard or baseline profile for encoding this more static form of video data, the techniques may enable nearly ubiquitous decoding this static video data by any display, including wireless display devices that receive video data via a wireless communication channel, considering that the standard or baseline profile is implemented by nearly every device that adheres to these standards. In addition, the standard or baseline profile often features a low implementation complexity in comparison to modified or new profiles and for this reason, the techniques may also provide a low complexity way of encoding static video data.

The techniques described herein may be implemented in hardware, firmware, or any combination thereof. The hardware may, in some instances, also execute software. Any features described as modules, units or components may be implemented together in an integrated logic device or separately as discrete but interoperable logic devices. In some cases, various features may be implemented as an integrated circuit device, such as an integrated circuit chip or chipset. If implemented in software, the techniques may be realized at least in part by a computer-readable medium comprising instructions that, when executed, cause a processor to perform one or more of the methods described above.

A computer-readable medium may form part of a computer program product, which may include packaging materials. A computer-readable medium may comprise a computer data storage medium such as random access memory (RAM), synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code or instructions may be executed by one or more processors, such as one or more DSPs, general purpose microprocessors, ASICs, field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated software modules or hardware modules. The disclosure also contemplates any of a variety of integrated circuit devices that include circuitry to implement one or more of the techniques described in this disclosure. Such circuitry may be provided in a single integrated circuit chip or in multiple, interoperable integrated circuit chips in a so-called chipset. Such integrated circuit devices may be used in a variety of applications, some of which may include use in wireless communication devices, such as mobile telephone handsets.

Various examples of the disclosure have been described. These and other examples are within the scope of the following claims.

1. A method for performing a non-scalable encoding process to encode video data that is to be wirelessly transmitted to a remote display device, the method comprising:
encoding, with a device, a portion of the video data at a first quality;
wirelessly transmitting, with the device, the encoded first portion to the remote display device;
identifying, with the device, a region of interest in the portion of the video data to be re-encoded at a second quality, wherein the second quality is higher than the first quality;
re-encoding, with the device, the identified region of interest at the second quality without re-encoding any other regions of the portion of the video data at the second quality; and
wirelessly transmitting, with the device, the re-encoded identified region of interest to the remote display device.

2. The method of claim 1,
wherein encoding a portion of the video data at a first quality comprising encoding, with a baseline encoder of the device, the portion of the video data at the first quality, wherein the baseline encoder implements a baseline profile defined by a H.264/Moving Pictures Experts Group-4 (MPEG-4) Part 10 Advanced Video Coding standard, and
wherein re-encoding the identified region of interest at the second quality without re-encoding any other regions of the portion of the video data at the second quality comprises re-encoding, with the baseline encoder, the identified region of interest at the second quality without re-encoding any other regions of the portion of the video data at the second quality comprises.

3. The method of claim 1, further comprising:
presenting the video data with a local display device;
monitoring the local display device to detect periods of relative inactivity in the video data presented by the local display device; and
when monitoring the local display device, detecting a change to the video data presented by the local display device,
wherein identifying a region of interest and re-encoding the identified region of interest occurs in a successive manner until either all regions of the portion of the video data are re-encoded at the second quality or a change is detected to the video data presented by the local display device.

4. The method of claim 3, wherein monitoring the local display device comprises detecting a timeout of a local display update capture for the local display device.

5. The method of claim 1, further comprising:
presenting the video data with a local display device;
storing data defining a threshold that identifies a level of change in the video data presented by the local display by which to determine whether to re-encode a new portion of the video data or only those regions of the portion impacted by a detected change;
monitoring the local display device to detect periods of relative inactivity in the video data presented by the local display device; and
when monitoring the local display device, detecting a change to the video data presented by the local display that impacts the portion of the video data;
determining an amount of the portion of the video data that is impacted by the detected change; and
comparing the determined amount to the threshold to determine whether to re-encode a new portion of the video data or only those regions of the portion impacted by the detected change,
wherein identifying a region of interest comprises, based on the determination to re-encode only those regions of the portion impacted by the detected change, identifying the region of interest as one of the one or more regions impacted by the detected change.

6. The method of claim 1, further comprising:
estimating an amount of capacity available on a wireless link over which the video data is wirelessly transmitted to the remote display device; and
determining the second quality based on the amount of capacity available on the wireless link.

7. The method of claim 6, wherein estimating an amount of capacity includes:
monitoring an amount of data stored to a transmission queue of a wireless interface of the device that is wirelessly communicatively coupled to the remote display device via the wireless link; and
estimating the amount of capacity available on the wireless link over which the video data is wireless transmitted to the remote display device based on the amount of data stored to the transmission queue.

8. The method of claim 1,
wherein identifying a region of interest and re-encoding the identified region of interest occurs in a successive manner until all regions of the portion of the video data is re-encoded at the second quality.
wherein the method further comprises:
storing data defining a time budget by which to complete re-encoding all of the regions of the portion of the video data at the second quality; and
determining the second quality based on the time budget.

9. The method of claim 1,
wherein the remote display device comprises a wireless display device,
wherein the device comprises a mobile device,
wherein the portion of the video data comprises a frame, and
wherein the identified region of interest comprises one or more blocks.

10. The method of claim 9, wherein the mobile device includes a local display device that presents the portion of the video data that is to be wirelessly transmitted to the wireless display device.

11. A device for performing a non-scalable encoding process to encode video data that is to be wirelessly transmitted to a remote display device, the device comprising:
a video encoder that encodes a portion of the video data at a first quality;
a wireless interface that wirelessly transmits the encoded first portion to the remote display device; and
a control unit identifies a region of interest in the portion of the video data to be re-encoded at a second quality, wherein the second quality is higher than the first quality,
wherein the video encoder re-encodes the identified region of interest at the second quality without re-encoding any other regions of the portion of the video data at the second quality, and
wherein the wireless interface wirelessly transmits the re-encoded identified region of interest to the remote display device.

12. The device of claim 11,
wherein the baseline video encoder implements a baseline profile defined by a H.264/Moving Pictures Experts Group-4 (MPEG-4) Part 10 Advanced Video Coding standard to encode the portion of the video data at the first quality and re-encode the identified region of interest at the second quality without re-encoding any other regions of the portion of the video data at the second quality comprises.

13. The device of claim 11, further comprising a local display device that presents the video data,
wherein the control unit further monitors the local display device to detect periods of relative inactivity in the video data presented by the local display device, when monitoring the local display device, detects a change to the video data presented by the local display device,
and identifies the region of interest and re-encodes the identified region of interest occurs in a successive manner until either all regions of the portion of the video data are re-encoded at the second quality or a change is detected to the video data presented by the local display device.

14. The device of claim 13, wherein the control unit further detects a timeout of a local display update capture for the local display device to detect the periods of relative inactivity in the video data presented by the local display device.

15. The device of claim 1, further comprising a local display device that presents the video data,
wherein the control unit further stores data defining a threshold that identifies a level of change in the video data presented by the local display by which to determine whether to re-encode a new portion of the video data or only those regions of the portion impacted by a detected change, monitors the local display device to detect periods of relative inactivity in the video data presented by the local display device, when monitoring the local display device, detects a change to the video data presented by the local display that impacts the portion of the video data, determines an amount of the portion of the video data that is impacted by the detected change and compares the determined amount to the threshold to determine whether to re-encode a new portion of the video data or only those regions of the portion impacted by the detected change and, based on the determination to re-encode only those regions of the portion impacted by the detected change, identifying the region of interest as one of the one or more regions impacted by the detected change.

16. The device of claim 11, wherein the control unit further estimates an amount of capacity available on a wireless link over which the video data is wirelessly transmitted to the remote display device and determines the second quality based on the amount of capacity available on the wireless link.

17. The device of claim 16, wherein the control unit further monitors an amount of data stored to a transmission queue of a wireless interface of the device that is wirelessly communicatively coupled to the remote display device via the wireless link and estimates the amount of capacity available on the wireless link over which the video data is wireless transmitted to the remote display device based on the amount of data stored to the transmission queue.

18. The device of claim 11,
wherein the control unit further identifies the region of interest and re-encodes the identified region of interest in a successive manner until all regions of the portion of the video data is re-encoded at the second quality, stores data defining a time budget by which to complete re-encoding all of the regions of the portion of the video data at the second quality, and determines the second quality based on the time budget.

19. The device of claim 11,
wherein the remote display device comprises a wireless display device,
wherein the device comprises a mobile device,
wherein the portion of the video data comprises a frame, and
wherein the identified region of interest comprises one or more blocks.

20. The device of claim 19, wherein the mobile device includes a local display device that presents the portion of the video data that is to be wirelessly transmitted to the wireless display device.

21. A device for performing a non-scalable encoding process to encode video data that is to be wirelessly transmitted to a remote display device, the device comprising:
means for encoding a portion of the video data at a first quality;
means for wirelessly transmitting the encoded first portion to the remote display device;
means for identifying a region of interest in the portion of the video data to be re-encoded at a second quality, wherein the second quality is higher than the first quality;
means for re-encoding the identified region of interest at the second quality without re-encoding any other regions of the portion of the video data at the second quality; and
means for wirelessly transmitting the re-encoded identified region of interest to the remote display device.

22. The device of claim 21,
wherein the means for encoding a portion of the video data at a first quality comprises means for encoding the portion of the video data at the first quality in accordance with a baseline profile defined by a H.264/Moving Pictures Experts Group-4 (MPEG-4) Part 10 Advanced Video Coding standard, and
wherein the means for re-encoding the identified region of interest at the second quality without re-encoding any other regions of the portion of the video data at the second quality comprises means for re-encoding the identified region of interest at the second quality in accordance with the baseline profile without re-encoding any other regions of the portion of the video data at the second quality comprises.

23. The device of claim 21, further comprising:
means for presenting the video data with a local display device;
means for monitoring the local display device to detect periods of relative inactivity in the video data presented by the local display device; and
when monitoring the local display device, means for detecting a change to the video data presented by the local display device,
wherein the means for identifying a region of interest and the means for re-encoding the identified region of interest comprise means for identifying the region of interest and means for re-encoding the identified region of interest in a successive manner until either all regions of the portion of the video data are re-encoded at the second quality or a change is detected to the video data presented by the local display device.

24. The device of claim 23, wherein the means for monitoring the local display device comprises means for detecting a timeout of a local display update capture for the local display device.

25. The device of claim 21, further comprising:
means for presenting the video data with a local display device;
means for storing data defining a threshold that identifies a level of change in the video data presented by the local display by which to determine whether to re-encode a new portion of the video data or only those regions of the portion impacted by a detected change;
means for monitoring the local display device to detect periods of relative inactivity in the video data presented by the local display device; and
when monitoring the local display device, means for detecting a change to the video data presented by the local display that impacts the portion of the video data;
means for determining an amount of the portion of the video data that is impacted by the detected change; and
means for comparing the determined amount to the threshold to determine whether to re-encode a new portion of the video data or only those regions of the portion impacted by the detected change,
wherein the means for identifying a region of interest comprises, based on the determination to re-encode only those regions of the portion impacted by the detected change, means for identifying the region of interest as one of the one or more regions impacted by the detected change.

26. The device of claim 21, further comprising:
means for estimating an amount of capacity available on a wireless link over which the video data is wirelessly transmitted to the remote display device; and
means for determining the second quality based on the amount of capacity available on the wireless link.

27. The device of claim 26, wherein the means for estimating an amount of capacity includes:
means for monitoring an amount of data stored to a transmission queue of a wireless interface of the device that is wirelessly communicatively coupled to the remote display device via the wireless link; and
means for estimating the amount of capacity available on the wireless link over which the video data is wireless transmitted to the remote display device based on the amount of data stored to the transmission queue.

28. The device of claim 21,
wherein the means for identifying a region of interest and the means for re-encoding the identified region of interest comprises means for identifying the region of interest and means for re-encoding the identified region of interest in a successive manner until all regions of the portion of the video data is re-encoded at the second quality,
wherein the device further comprises:
means for storing data defining a time budget by which to complete re-encoding all of the regions of the portion of the video data at the second quality; and
means for determining the second quality based on the time budget.

29. The device of claim 21,
wherein the remote display device comprises a wireless display device,
wherein the device comprises a mobile device,
wherein the portion of the video data comprises a frame, and
wherein the identified region of interest comprises one or more blocks.

30. The device of claim 29, wherein the mobile device includes a local display device that presents the portion of the video data that is to be wirelessly transmitted to the wireless display device.

31. A non-transitory computer-readable storage medium comprising instructions for performing a non-scalable encoding process to encode video data that is to be wirelessly transmitted to a remote display device, the instructions, when executed, causing one or more processor to:
encode a portion of the video data at a first quality;
wirelessly transmit the encoded first portion to the remote display device;
identify a region of interest in the portion of the video data to be re-encoded at a second quality, wherein the second quality is higher than the first quality;
re-encode the identified region of interest at the second quality without re-encoding any other regions of the portion of the video data at the second quality; and
wirelessly transmit the re-encoded identified region of interest to the remote display device.

32. The non-transitory computer readable storage medium of claim 31, further comprising instructions that, when executed, cause the one or more processors to:
encode the portion of the video data at the first quality in accordance with a baseline profile defined by a H.264/Moving Pictures Experts Group-4 (MPEG-4) Part 10 Advanced Video Coding standard; and
re-encode the identified region of interest at the second quality in accordance with the baseline profile without re-encoding any other regions of the portion of the video data at the second quality comprises.

33. The non-transitory computer readable storage medium of claim 31, further comprising instructions that, when executed, cause the one or more processors to:
present the video data via a local display device;
monitor the local display device to detect periods of relative inactivity in the video data presented by the local display device; and
when monitoring the local display device, detect a change to the video data presented by the local display device,
identify a region of interest and re-encode the identified region of interest in a successive manner until either all regions of the portion of the video data are re-encoded at the second quality or a change is detected to the video data presented by the local display device.

34. The non-transitory computer readable storage medium of claim 33, further comprising instructions that, when executed, cause the one or more processors to detect a timeout of a local display update capture for the local display device.

35. The non-transitory computer readable storage medium of claim 31, further comprising instructions that, when executed, cause the one or more processors to:
present the video data with a local display device;
store data defining a threshold that identifies a level of change in the video data presented by the local display by which to determine whether to re-encode a new portion of the video data or only those regions of the portion impacted by a detected change;
monitor the local display device to detect periods of relative inactivity in the video data presented by the local display device; and
when monitoring the local display device, detect a change to the video data presented by the local display that impacts the portion of the video data;
determine an amount of the portion of the video data that is impacted by the detected change;
compare the determined amount to the threshold to determine whether to re-encode a new portion of the video data or only those regions of the portion impacted by the detected change; and
based on the determination to re-encode only those regions of the portion impacted by the detected change, identify the region of interest as one of the one or more regions impacted by the detected change.

36. The non-transitory computer readable storage medium of claim 31, further comprising instructions that, when executed, cause the one or more processors to:
estimate an amount of capacity available on a wireless link over which the video data is wirelessly transmitted to the remote display device; and
determine the second quality based on the amount of capacity available on the wireless link.

37. The non-transitory computer readable storage medium of claim 36, further comprising instructions that, when executed, cause the one or more processors to:
monitor an amount of data stored to a transmission queue of a wireless interface of the device that is wirelessly communicatively coupled to the remote display device via the wireless link; and
estimate the amount of capacity available on the wireless link over which the video data is wireless transmitted to the remote display device based on the amount of data stored to the transmission queue.

38. The non-transitory computer readable storage medium of claim 31, further comprising instructions that, when executed, cause the one or more processors to:
identify a region of interest and re-encode the identified region of interest in a successive manner until all regions of the portion of the video data is re-encoded at the second quality;
store data defining a time budget by which to complete re-encoding all of the regions of the portion of the video data at the second quality; and
determine the second quality based on the time budget.

39. The non-transitory computer readable storage medium of claim 31, further comprising instructions that, when executed, cause the one or more processors to:
wherein the remote display device comprises a wireless display device,
wherein the one or more processors are included in a a mobile device,
wherein the portion of the video data comprises a frame, and
wherein the identified region of interest comprises one or more blocks.

40. The non-transitory computer readable storage medium of claim 39, wherein the mobile device includes a local display device that presents the portion of the video data that is to be wirelessly transmitted to the wireless display device.
